(19) United States
(12) Patent Application Publication
(10) Pub. No.: US 2007/0222853 A1
(43) Pub. Date: Sep. 27, 2007

(54) Electronic device for simulating the optical perspective of animals, reptiles, fish, insects, birds and other creatures

(76) Inventors: Barra Grant, Santa Monica, CA (US); Brian Reilly, Santa Monica, CA (US)

Correspondence Address: William Propp, Esq., PMB1-245, 8205 Santa Monica Blvd., West Hollywood, CA, 90046, US

(21) Appl. No.: 11/388,821

(22) Filed: Mar. 24, 2006

(51) Int. Cl. H04N 5/14

(52) U.S. Cl. 348/25

(57) ABSTRACT

An electronic device simulates the optical perspective of animals, reptiles, fish, insects, birds and other creatures for a human viewer. The electronic device has an input sensor to collect optical images of the outside surrounding environment and convert the optical images to electronic images, an image processor to transform the electronic images from the input sensor to the appropriate creature perspective electronic images, and an output display to convert the creature perspective electronic images to creature perspective visual images to the human viewer.

### BACKGROUND OF THE INVENTION

This invention relates generally to an electronic device having one or more electronic elements and, more particularly, this invention is directed to an electronic device, which allows the human viewer to simulate the optical perspective of animals, reptiles, fish, insects, birds and other creatures.

Optical elements are often used to correct the distortions in the eyesight of the human viewer. Eyeglasses and contact lenses are classic examples of improving the optical perspective of the human viewer.

Occasionally, optical elements are used to deliberately distort the eyesight of the human viewer. Fresnel lenses in goggles are used to simulate the disorientation caused by intoxication in U.S. Pat. No. 6,206,521. Mis-shapen lenses and mirrors are also used to simulate a drunk or drugged state in the viewer.

A color filter in a monocle in U.S. Pat. No. 5,541,735 allows a hunter to select camouflage clothing to blend into a specific outdoors background during dim light. In this patent, the monocle filters out red since deer and other trophy hunting animals cannot see red.

Electronic devices can also be used to correct the distortions in the eyesight of the human viewer. A light sensor and image processing circuit on a pair of eyeglasses reduces light intensity in U.S. Pat. No. 5,841,507. An imaging sensor system corrects a distorted optical image caused by a wide-angle lens in U.S. Pat. No. 5,489,940.

Night vision goggles collect the low amounts of ambient light, convert the light to electrical signals, and intensify the number and intensity of the electrical signals. The electrical signals strike a green phosphor screen and the screen is observed by the human viewer. Alternately, the night vision goggles can collect the infrared light, which is emitted by heat rather than reflected light, scan the infrared light with infrared detectors and display the resulting thermogram to the human viewer.

It is an object of this invention to provide an electronic device with one or more electronic elements, which allows the human viewer to simulate the optical perspective of animals, reptiles, fish, insects, birds and other creatures.

### SUMMARY OF THE INVENTION

According to the present invention, an electronic device allows the human viewer to simulate the optical perspective of animals, reptiles, fish, insects, birds and other creatures of the outside surrounding environment.

The electronic device has an input sensor, an image processor and an output display. The input sensor, such as a charge-coupled device (CCD), will collect optical images of the outside surrounding environment and convert the optical images to electronic images. The image processor, such as an image processing circuit or an image processing program on a computer chip, will transform the electronic images from the input sensor to the appropriate creature perspective electronic images of the outside surrounding environment. The output display, such as a liquid crystal display (LCD), will convert the creature perspective electronic images to creature perspective visual images of the outside surrounding environment observable to the human viewer. The electronic device operates in real-time or near real-time.

The input sensor or the input sensor element will be a solid-state photosensitive or photoreceptive element, such as a charge coupled device (CCD), a complementary metal-oxide semiconductor (CMOS) array, or a charge injection diode (CID) array.

The image processor will be an image processing circuit or an image processing program on a computer chip.

The image processor can have a single predetermined procedure on the image processing circuit or a single computer program on the chip to transform the original image to the optical perspective of one specified creature.

Alternately, the image processor can have multiple predetermined procedures on the image processing circuit or a multiple computer programs on the chip to transform the original image to the optical perspective of multiple specified creatures, one transformation of one optical perspective of one specified creature at a time.

The output display or the output display element of the electronic device of the present invention will be a liquid crystal display (LCD).

The image processor can be replaceable or reprogrammable to change the optical perspective of an animal, a reptile, a fish, an insect, a bird or another creature for the electronic device.

There are several different optical devices for the present invention, such as a monocle, a monocular, a telescope, binoculars, goggles, a mask, a visor or a helmet.

Other aspects of the invention will become apparent from the following more detailed description, taken in conjunction with the accompanying drawings.

### BRIEF DESCRIPTION OF THE DRAWINGS

The preferred embodiments of this invention will be described in detail, with reference to the following figures wherein:

FIG. 1 is a side schematic view of an electronic device for simulate the optical perspective of animals, reptiles, fish, insects, birds and other creatures to a human viewer of the present invention.

FIG. 2 is a side schematic view of a second embodiment of an electronic device for simulate the optical perspective of animals, reptiles, fish, insects, birds and other creatures to a human viewer.

FIG. 3 is a side schematic view of a replaceable image processor of the electronic device of FIG. 1.

FIG. 4 is a side schematic view of a reprogrammable image processor of the electronic device of FIG. 1.

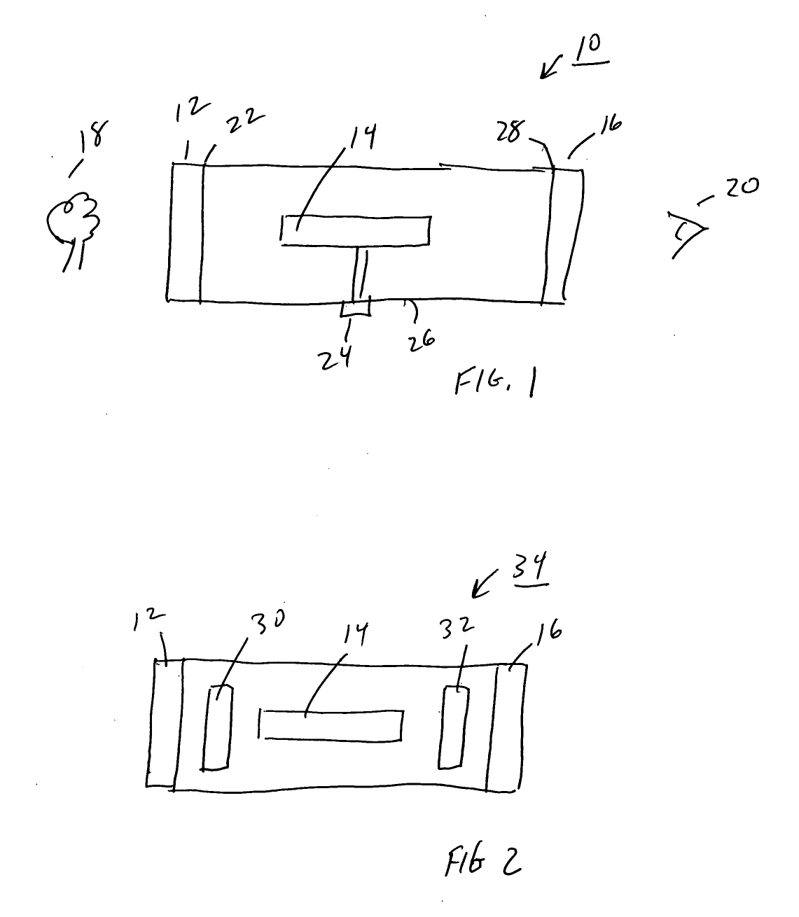

### DETAILED DESCRIPTION OF PREFERRED EMBODIMENTS

Reference is now made to FIG. I illustrating an electronic device 10, which allows the human viewer to simulate the optical perspective of animals, reptiles, fish, insects, birds and other creatures.

The electronic device 10 has an input sensor 12, an image processor 14 and an output display 16. The input sensor 12, such as a charge-coupled device (CCD), will collect optical images of the outside surrounding environment 18 and convert the optical images to electronic images. The image processor 14, such as an image processing circuit or an image processing program on a computer chip, will transform the electronic images from the input sensor to the appropriate creature perspective electronic images of the outside surrounding environment. The output display 16, such as a liquid crystal display (LCD), will convert the creature perspective electronic images to creature perspective visual images of the outside surrounding environment observable to the human viewer 20. The electronic device 10 operates in real-time or near real-time.

The input sensor 12 is oriented towards the outside surrounding environment 18. The output display 16 is oriented towards the eye or eyes of the human viewer 20.

There are several different electronic devices for the present invention.

Monoculars and telescopes have a tubular barrel with an eyepiece at each of the two ends of the barrel. A binocular has two adjacent parallel tubular barrels with an eyepiece at each of the two ends of each of the two barrels.

A monocle, a mask and a visor have a single eyepiece with no barrel. Alternately, the mask and visor can have two eyepieces with no barrel.

Goggles have two eyepieces with no barrel.

A helmet can have a single eyepiece with no barrel, two eyepieces with no barrel, a tubular barrel with an eyepiece at each of the two ends of the barrel or two adjacent parallel tubular barrels with an eyepiece at each of the two ends of each of the two barrels.

The electronic devices of the present invention can be divided into hand-held and hands-free operation.

The hand-held electronic devices would include the monocular, the binoculars, and the telescope. All these electronic devices require at least one hand to hold them in position in front of the eye or eyes of the viewer.

The hands-free electronic devices would include the goggles, the visor, the mask and the helmet. The goggles, visor and mask can either have a frame, which extends behind the ears of the viewer, or straps, which attach behind the head of the viewer. The helmet will rest on the head of the viewer and may or may not have straps, which attach below the chin of the viewer.

The input sensor of the electronic device of the present invention will typically be positioned on the front outer surface 22 of the electronic device 10 towards the outside surrounding environment 18. The input sensor will approximately align between or be parallel to the eyes or eye of the human viewer and the outside surrounding environment.

The input sensor can be one or more input sensor elements.

The monocle, the monocular and the telescope will typically have one input sensor element at the front eyepiece for one eye of the viewer.

The binoculars and the goggles will have two input sensor elements at the front eyepieces with one input sensor element for each eye of the viewer.

The mask and the visor can have two different input sensor element configurations. First, the mask and visor can have one input sensor element for both eyes of the viewer. Second, the mask and visor can have two adjacent input sensor elements with one input sensor element for each eye of the viewer.

The helmet can have one input sensor element at the front eyepiece for one eye of the viewer or two input sensor elements at the front eyepieces with one input sensor element for each eye of the viewer or one input sensor element at the front eyepiece for both eyes of the viewer.

The input sensor elements can extend to the left and right sides, or top and bottom sides, of the optical device. Some of the creatures have better peripheral vision than humans. The side input sensor elements allows the human viewer to simulate the optical perspective of a creature with peripheral vision.

The input sensor or the input sensor element will be a solid-state photosensitive or photoreceptive element, such as a charge coupled device (CCD), a complementary metal-oxide semiconductor (CMOS) array, or a charge injection diode (CID) array.

The input sensor 12 will collect or scan optical images of the outside surrounding environment 18 in real-time or near real-time on a pixel by pixel basis or a group of pixels by group of pixels basis and convert each pixel or group of pixels into an electronic image signal in real-time or near real-time which is sent to the optical processor 16.

If the output image for the electronic device is black and white or monochrome, the input sensor will just measure the intensity of the light at the pixel or group of pixels to form the electronic image signal. If the output image for the electronic device is color, the electronic signal will measure the intensity of the light in red, green and blue, or in cyan, magenta and yellow, at the pixel or group of pixels to form the electronic image signal.

The electronic image signals from the input sensor will form an original image of the outside surrounding environment.

If the electronic image signal from the input sensor is a digital image signal, the digital image signal will be sent to the image processor. If the electronic image signal from the input sensor is an analog image signal, the analog image signal will be converted by an A/D converter (not shown) to a digital image signal, and the digital image signal will be sent to the image processor.

Image sensors or image scanners other than CCD, CMOS and CID array can be used as the input sensor for the electronic device of the present invention. The image sensors must be able to collect or scan optical images of the outside surrounding environment in real-time or near real-time on a pixel by pixel basis or a group of pixels by group of pixels basis and convert each pixel or group of pixels into an electronic image signal in real-time or near real-time which is sent to the optical processor.

The image processor 16 of the electronic device of the present invention will typically be internal to the electronic device 12. The image processor will be an image processing circuit or an image processing program on a computer chip to convert the electronic image signals in real-time or near real-time into the appropriate creature perspective electronic image signals.

The image processing circuit will execute a predetermined procedure to transform the electronic image signals from the input sensor to the electronic image signals of a particular optical perspective of a creature, such as one of the animals, reptiles, fish, insects, birds or other creatures.

The image processing program on a computer chip will achieve the same optical transformation effect by executing a computer program to transform the electronic image signals from the input sensor to the electronic image signals of a particular optical perspective of a creature, such as one of the animals, reptiles, fish, insects, birds or other creatures.

The optical characteristics of each creature will vary by creature but may involve adjusting color sensitivity, adjusting brightness, optically distorting the complete image, magnifying the image, focusing the image, providing a compound image, adjusting the polarization of the image, image compression, image expansion, to cite a few non-exhaustive examples.

The image processor can perform one or more optical transformations to the original image to simulate the optical perspective of a different animal, reptile, fish, insect, bird or creature for a human viewer.

Illustrative but not exhaustive examples follow:

A spider has eight eyes. The spider has two larger front eyes to see distant objects, two small front eyes to see closer objects and four small side eyes to judge peripheral motion.

The image processor will transform the electronic data signals that form the complete original image to magnify two image areas, to focus on another two image areas and to shift four areas on the sides of the image to the front of the image to form the creature optical perspective of the image.

An insect has a compound eye and views objects and the surroundings as a course mosaic. An ant has 9 compound lenses. A bee has 3,000 to 4,000 compound lenses. A dragonfly has more than 30,000 compound lenses.

The image processor will transform the electronic data signals that form the complete original image to repeat a smaller version of the image by 9, by 3,000 to 4,000, or by 30,000, to form the creature optical perspective of the image.

A bee's vision is sensitive towards the ultraviolet spectrum. Bees see the surroundings in blue, yellow and ultraviolet.

The image processor will transform the electronic data signals that form the complete original image to enhance the blue and yellow in the image, pixel by pixel or group of pixels by group of pixels, and/or to decrease the red and green in the image, pixel by pixel or group of pixels by group of pixels, to form the creature optical perspective of the image.

A dragonfly cannot distinguish blues, violets and ultraviolets.

The image processor will transform the electronic data signals that form the complete original image to enhance the red and green in the image, pixel by pixel or group of pixels by group of pixels, and/or to decrease the blue in the image, pixel by pixel or group of pixels by group of pixels, to form the creature optical perspective of the image.

Salt-water fish are sensitive to blue light.

The image processor will transform the electronic data signals that form the complete original image to enhance the blue in the image, pixel by pixel or group of pixels by group of pixels, and/or to decrease the green and red in the image, pixel by pixel or group of pixels by group of pixels, to form the creature optical perspective of the image.

Freshwater fish are sensitive to red light.

The image processor will transform the electronic data signals that form the complete original image to enhance the red in the image, pixel by pixel or group of pixels by group of pixels, and/or to decrease the green and blue in the image, pixel by pixel or group of pixels by group of pixels, to form the creature optical perspective of the image.

A shark is color-blind and far-sighted.

The image processor will transform the electronic data signals that form the complete original image to decrease the green, red and blue in the image, pixel by pixel or group of pixels by group of pixels, and to magnify the image to form the creature optical perspective of the image.

An octopus or squid has a fixed focus lens and rectangular pupil that contracts to an narrow horizontal slit. An octopus or squid only sees colored light in the blue green spectrum; the rest of the light is viewed as black and white.

The image processor will transform the electronic data signals that form the complete original image to obscure all but a horizontal slit of the image, to flatten the image, to enhance the green and blue in the image, pixel by pixel or group of pixels by group of pixels, and/or to decrease the red in the image, pixel by pixel or group of pixels by group of pixels, to form the creature optical perspective of the image.

A frog has similar eyesight to the squid or octopus. A frog only sees colored light in the blue spectrum and has near spherical eyes to give the frog a panoramic view of its surroundings.

The image processor will transform the electronic data signals that form the complete original image to enhance the blue in the image, pixel by pixel or group of pixels by group of pixels, and/or to decrease the red in the image, pixel by pixel or group of pixels by group of pixels, and to compress a wider view of the image including the sides into a smaller area to form the creature optical perspective of the image.

Turtles are sensitive to colors in the longer wavelengths, yellows, oranges and reds.

The image processor will transform the electronic data signals that form the complete original image to enhance the yellow and reds in the image, pixel by pixel or group of pixels by group of pixels, and/or to decrease the blue and greens in the image, pixel by pixel or group of pixels by group of pixels to form the creature optical perspective of the image.

Crocodiles, alligators and lizards all have a slit pupil and tunnel vision. The tunnel vision allows predators, like crocodiles, alligators and lizards, to focus with fine detail on prey and other objects in their surroundings.

The image processor will transform the electronic data signals that form the complete original image to obscure all but a horizontal slit of the image, and to magnify a smaller front area of the image to form the creature optical perspective of the image.

The eyes of snakes respond to normal light and the sensing pits of the snake next to the eyes respond to the infrared. The infrared perspective means a snake can sense heat, usually the body temperature of its prey.

The image processor will transform the electronic data signals that form the complete original image to enhance the near-reds and infrareds in the image, pixel by pixel or group of pixels by group of pixels to form the creature optical perspective of the image.

Predator birds, such as hawks, falcons, and eagles, have both strong tunnel vision and excellent peripheral vision.

The image processor will transform the electronic data signals that form the complete original image to magnify a smaller front area of the image and to compress a wider view of the image including the sides into a smaller area to form the creature optical perspective of the image.

Seabirds, such as gulls, terns and cormorants, are sensitive to red light, filtering out blues and greens to see objects on the surface or water or underwater and are polarization sensitive to filter out bright sunlight, particularly sunlight reflected off water.

The image processor will transform the electronic data signals that form the complete original image to enhance the red in the image, pixel by pixel or group of pixels by group of pixels, and/or to decrease the blue and greens in the image, pixel by pixel or group of pixels by group of pixels, and to polarize the image to form the creature optical perspective of the image.

Nocturnal birds, such as owls, have tunnel vision and are color-blind.

The image processor will transform the electronic data signals that form the complete original image to magnify a smaller front area of the image and to decrease the green, red and blue in the image, pixel by pixel or group of pixels by group of pixels, to form the creature optical perspective of the image.

Hummingbirds are drawn to light in the red spectrum.

The image processor will transform the electronic data signals that form the complete original image to enhance the red in the image, pixel by pixel or group of pixels by group of pixels, and/or to decrease the blue and greens in the image, pixel by pixel or group of pixels by group of pixels to form the creature optical perspective of the image.

A chicken is near-sighted.

The image processor will transform the electronic data signals that form the complete original image to focus a smaller front area of the image to form the creature optical perspective of the image.

A pigeon is sensitive to polarized light and sees colored light in the red spectrum, the blue and green light is viewed as black and white.

The image processor will transform the electronic data signals that form the complete original image to polarize the image and to enhance the red in the image, pixel by pixel or group of pixels by group of pixels, and/or to decrease the blue and greens in the image, pixel by pixel or group of pixels by group of pixels to form the creature optical perspective of the image.

Dogs, as is popularly known, are color-blind.

The image processor will transform the electronic data signals that form the complete original image to decrease the green, red and blue in the image, pixel by pixel or group of pixels by group of pixels, to form the creature optical perspective of the image.

Cats are slightly near-sighted, have excellent low-light or near darkness vision and have an elliptical pupil, the “cat's eye”.

The image processor will transform the electronic data signals that form the complete original image to obscure all but an elliptical slit of the image, to enhance the near-reds and infrareds in the image, pixel by pixel or group of pixels by group of pixels, and to focus a smaller front area of the image to form the creature optical perspective of the image.

Rabbits are typically prey and accordingly have a wide field of vision.

The image processor will transform the electronic data signals that form the complete original image to compress a wider view of the image including the sides into a smaller area to form the creature optical perspective of the image.

Squirrels can only see light in the blue and yellow spectrum and have a wide field of vision.

The image processor will transform the electronic data signals that form the complete original image to enhance the blue and yellow in the image, pixel by pixel or group of pixels by group of pixels, and/or to decrease the red and green in the image, pixel by pixel or group of pixels by group of pixels and to compress a wider view of the image including the sides into a smaller area to form the creature optical perspective of the image.

Some monkeys are red-green color-blind.

The image processor will transform the electronic data signals that form the complete original image to enhance the blue in the image, pixel by pixel or group of pixels by group of pixels, and/or decrease the green and red in the image, pixel by pixel or group of pixels by group of pixels, to form the creature optical perspective of the image.

Lions and tigers see reduced green, blue and yellow. They do not see red. They do see several shades of grey.

The image processor will transform the electronic data signals that form the complete original image to decrease the green, blue, and yellow in the image, pixel by pixel or group of pixels by group of pixels, and to eliminate the red in the image, pixel by pixel or group of pixels by group of pixels, to form the creature optical perspective of the image.

An elephant is near-sighted. It has trouble seeing faraway objects until they get close.

The image processor will transform the electronic data signals that form the complete original image to focus a smaller front area of the image to form the creature optical perspective of the image.

A bat is nocturnal and tends to rely on echolocation to determine their position and hunt prey.

The image processor will transform the electronic data signals that form the complete original image to enhance the near-reds and infrareds in the image, pixel by pixel or group of pixels by group of pixels to form the creature optical perspective of the image.

These optical elements are merely illustrative examples of optical elements to simulate the optical perspective of common animals, reptiles, fish, insects, birds and other creatures. The present invention can simulate the optical perspective of other animals, reptiles, fish, insects, birds and creatures.

The image processor 14 will receive the electronic image signals from the input sensor 12. The image processor will then transform in real-time or near real-time the electronic image signals of the outside surrounding environment to electronic image signals of the optical perspective of the appropriate creature optical perspective of the outside surrounding environment. The image processor 14 will then send the creature perspective electronic image signals to the output display 16.

The image processor can have a single predetermined procedure on the image processing circuit or a single computer program on the chip to transform the original image to the optical perspective of one specified creature.

Alternately, the image processor can have multiple predetermined procedures on the image processing circuit or a multiple computer programs on the chip to transform the original image to the optical perspective of multiple specified creatures, one transformation of one optical perspective of one specified creature at a time.

An external switch 24 on the outside surface 26 of the electronic device 10 will connect to the internal image processor 14. The switch can be a multiple position switch or a control knob with each position on the switch operating a different creature perspective optical transformation in the image processor. Alternately, the switch can be a push button switch with each push sequentially operating a different creature perspective optical transformation in the image processor.

The switch can also be used to turn the electronic device of the present invention on and off.

The output display 16 of the electronic device 12 of the present invention will be a liquid crystal display (LCD).

The output display 16, such as the liquid crystal display (LCD), will convert the creature perspective electronic image signals from the optical processor 14 to creature perspective visual image signals in real-time or near real-time on a pixel by pixel basis or a group of pixels by group of pixels basis for a creature perspective image of the outside surrounding environment to be observed by the human viewer.

The creature perspective electronic image signal from the optical processor is a digital image signal. If the output display requires a digital image signal, the creature perspective electronic image signal from the optical processor will be sent to the output display. If the output display requires an analog image signal, the creature perspective electronic image signal from the optical processor will be converted by a D/A converter (not shown) and the analog image signal will be sent to the output display.

Output displays, other than LCD, such as image projection, CRT or fiber optics, can be used as output display for the electronic device of the present invention. The output displays must be able to convert the creature perspective electronic image signals from the optical processor to creature perspective visual image signals in real-time or near real-time on a pixel by pixel basis or a group of pixels by group of pixels basis for a creature perspective image of the outside surrounding environment to be observed by the human viewer.

The output display 16 of the electronic device 10 of the present invention will typically be positioned on a back surface 28 of the electronic device towards the eye or eyes of the human viewer 20. The output display will approximately align with the eye or eyes of the human viewer.

The output display can be one or more output display elements.

The monocle, the monocular and the telescope will typically have one output display element at the back eyepiece for one eye of the viewer. The output display element is on the back outer surface of the electronic device.

The binoculars and the goggles will have two output display elements at the back eyepieces with one output display element for each eye of the viewer. The output display elements are on the back outer surface of the electronic device.

The mask and the visor can have two different output display element configurations.

First, the mask and visor can have one output display element for both eyes of the viewer. The output display element is on the front inner surface of the electronic device.

Second, the mask and visor can have two adjacent output display elements with one output display element for each eye of the viewer. The output display elements are on the front inner surface of the electronic device.

The helmet can have one output display element at the front inner surface of the electronic device for one eye of the viewer or two output display elements at the front inner surface with one output display element for each eye of the viewer or one output display element at the front inner surface for both eyes of the viewer.

Alternately as shown in FIG. 2, an image data buffer 30 can be provided between the input sensor 12 and the image processor 14 to temporarily store the electronic image signals before the image processor transforms the image signals. An output data buffer 32 can be provided between the image processor 14 and the output display 16 to temporarily store the creature perspective electronic image signals before the output display converts the signals to be displayed. The electronic device 34 can have either buffer or both buffers.

Either buffer can store the image signals after transformation by the image processor and the output data buffer can store the image signals after conversion by the output display. Both buffers should operate in real-time or near real-time to allow the electronic device and the input sensor, the image processor and the output display to operate in real-time or near real-time.

The image processor can be replaceable to change the creature optical perspectives in the image processor.

As shown in FIG. 3, an opening in the outer surface of the electronic device will allow access to the image processor to remove a first image processor and substitute a second image processor. The second image processor will provide one or more different creature optical perspective programs or circuits than the first image processor.

Alternately, one or more different creature optical perspective image processor programs can be changed within the image processor.

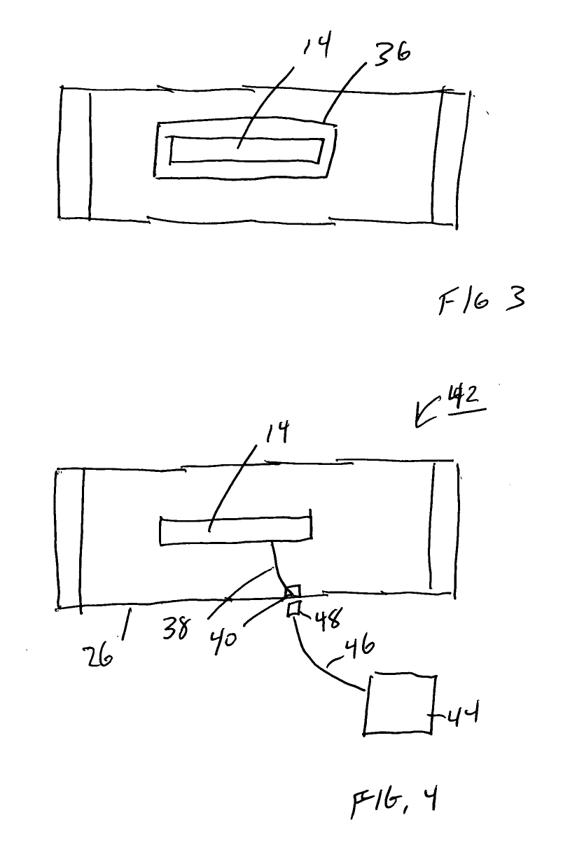

As shown in FIG. 4, the internal image processor 14 can be electrically connected by conductive wire 38 to a female connector 40 at the outer surface 26 of the electronic device 42. An external control source 44 will be electrically connected by conductive wire 46 to a male connector 48, which is inserted in the female connector to reprogram the image processor. The reprogrammable connection would be temporary but repeatable. The control source, typically a computer, can alter the image processing circuit or image processing program on the computer chip of the image processor 14 to change one or more different creature optical perspectives.

Alternately, the external control source can be external to the electronic device. The external control source, again typically a computer, can be electrically connected by conductive wire through the outer surface of the electronic device to the internal image processor.

Alternately, the image processor can be external on the outer surface of the electronics device. The image processor can be removed and replaced. Also alternately, one or more different creature optical perspective image processor programs in the image processor can be changed by an external control source by means and methods described previously.

The electronic elements of the input sensor, the image processor and the output display of the optical device of the present invention will all require a power source.

The power source will typically be a battery. Each electronic element of the input sensor, the image processor and the output display can have a separate power source battery. Each battery would meet or exceed the power needs of the electronic element. Alternately, a single power source battery could be used for all three electronic elements of the device. The battery could supply power to all electronic elements in series or in parallel.

The battery power source will be internal to the electronic device. The battery power source can be replaceable or rechargeable.

If the battery is replaceable, then an opening in the outer surface of the electronic device will allow access to the battery to remove a depleted battery and substitute a charged battery.

If the battery is rechargeable, then the internal battery will be electrically connected by conductive wire to a female connector at the outer surface of the electronic device. An external power source will be electrically connected by conductive wire to a male connector, which is inserted in the female connector to recharge the battery power source. The electrical connection would be temporary but repeatable.

Alternately, the battery power source can be external to the electronic device. The battery power source will typically be a battery pack with a rechargeable or replaceable battery. The external battery pack can be electrically connected by conductive wire through the outer surface of the electronic device to the internal electronic elements.

Alternately, the external battery pack can be electrically connected by conductive wire to a male connector. The internal electronic elements will be electrically connected by conductive wire to a female connector at the outer surface of the electronic device. The male connector is inserted in the female connector to provide the battery power source for the electronic device.

The external battery pack can be mounted on the outer surface of the electronic device or mounted on the human viewer.

The power source for the electronic device is not limited to batteries. Solar cells and other power supplies can be used as the power source.

The power source should be lightweight and ideally positioned within or outside the electronic device to help balance the weight of the electronic device on the human viewer.

If the electronic device is used underwater, then the electronic device, typically the mask or goggles, should be waterproof.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. An electronic device comprising
an input sensor for converting an image of the outside surrounding environment into electronic image signals;
an image processor for transforming said electronic image signals into creature perspective electronic image signals; and
an output display for converting said creature perspective electronic image signals into an image of the outside surrounding environment from the optical perspective of an animal, a reptile, a fish, an insect, a bird or another creature observable to a human viewer.

2. The electronic device of claim 1 wherein said input sensor, said image processor and said output display operate in real-time or near real-time.

3. The electronic device of claim 1 wherein said input sensor is a charge coupled device (CCD), a complementary metal-oxide semiconductor (CMOS) array, or a charge injection diode (CID) array.

4. The electronic device of claim 1 wherein said image processor is an image processing circuit or an image processing program on a computer chip,

5. The electronic device of claim 1 wherein said output display is a liquid crystal display (LCD).

6. The electronic device of claim 1 wherein said image processor is replaceable in said electronic device.

7. The electronic device of claim 1 wherein said image processor is reprogrammable in said electronic device for changing the optical perspective of an animal, a reptile, a fish, an insect, a bird or another creature.

8. The electronic device of claim 1 wherein said image processor will transform said electronic image signals into creature perspective electronic image signals for the optical perspective of a single creature.

9. The electronic device of claim 1 wherein said image processor will transform said electronic image signals into creature perspective electronic image signals for the optical perspective of multiple creatures, the optical perspective of one specified creature at a time.

10. The electronic device of claim 1 wherein said electronic device is a monocle, wherein said input sensor is positioned at the front surface of said monocle, said output display is positioned at the back surface of said monocle, and said image processor is between said input sensor and said output display.

11. The electronic device of claim 1 wherein said electronic device is a monocular, wherein said input sensor is positioned at the front eyepiece of said monocular, said output display is positioned at the back eyepiece of said monocular, and said image processor is between said input sensor and said output display in a single barrel of said monocular.

12. The electronic device of claim 1 wherein said electronic device is a telescope, wherein said input sensor is positioned at the front eyepiece of said telescope, said output display is positioned at the back eyepiece of said telescope, and said image processor is between said input sensor and said output display in a single barrel of said telescope.

13. The electronic device of claim 1 wherein said electronic device is a binocular having a first barrel and a second barrel, wherein said first input sensor is positioned at the front eyepiece of said first barrel of said binocular, said first output display is positioned at the back eyepiece of said first barrel of said binocular, wherein said second input sensor is positioned at the front eyepiece of said second barrel of said binocular, said second output display is positioned at the back eyepiece of said second barrel of said binocular, and at least one of said image processors is positioned in at least one of said first barrel and said second barrel of said binocular.

14. The electronic device of claim 1 wherein said electronic device is goggles having a first eyepiece and a second eyepiece, wherein said first input sensor is positioned at the front surface of said first eyepiece of said goggles, said first output display is positioned at the back surface of said first eyepiece of said goggles, said second input sensor is positioned at the front surface of said second eyepiece of said goggles, and said second output display is positioned at the back surface of said second eyepiece of said goggles.

15. The electronic device of claim 1 wherein said electronic device is a mask, wherein said input sensor is positioned at the front surface of said mask, said output display is positioned at the back surface of said mask.

16. The electronic device of claim 1 wherein said electronic device is a mask having a first eyepiece and a second eyepiece, wherein said first input sensor is positioned at the front surface of said first eyepiece of said mask, said first output display is positioned at the back surface of said first eyepiece of said mask, said second input sensor is positioned at the front surface of said second eyepiece of said mask, and said second output display is positioned at the back surface of said second eyepiece of said mask.

17. The electronic device of claim 1 wherein said electronic device is a visor, wherein said input sensor is positioned at the front surface of said visor, said output display is positioned at the back surface of said visor.

18. The electronic device of claim 1 wherein said electronic device is a visor having a first eyepiece and a second eyepiece, wherein said first input sensor is positioned at the front surface of said first eyepiece of said visor, said first output display is positioned at the back surface of said first eyepiece of said visor, said second input sensor is positioned at the front surface of said second eyepiece of said visor, and said second output display is positioned at the back surface of said second eyepiece of said visor.

19. The electronic device of claim 1 wherein said electronic device is a helmet, wherein said input sensor is positioned at the front surface of said helmet, said output display is positioned at the back surface of said helmet.

20. The electronic device of claim 1 wherein said electronic device is a helmet having a first eyepiece and a second eyepiece, wherein said first input sensor is positioned at the front surface of said first eyepiece of said helmet, said first output display is positioned at the back surface of said first eyepiece of said helmet, said second input sensor is positioned at the front surface of said second eyepiece of said helmet, and said second output display is positioned at the back surface of said second eyepiece of said helmet.
